(19) United States
(12) Patent Application Publication
(10) Pub. No.: US 2019/0193253 A1
(43) Pub. Date: Jun. 27, 2019

(54) Anti-Slip Screwdriver Bit

(71) Applicant: Andrew John FORAN, McGrath's Cove (CA)

(72) Inventor: Andrew John FORAN, McGrath's Cove (CA)

(21) Appl. No.: 15/851,992

(22) Filed: Dec. 22, 2017

(51) Int. Cl. B25B 23/10; B25B 15/00

(52) U.S. Cl. CPC B25B 23/108; B25B 21/00; B25B 15/008; B25B 15/005

(57) ABSTRACT

An anti-slip screwdriver bit for transmitting torque to a screw-head. The anti-slip screwdriver bit comprises a shaft for receiving the torque about its longitudinal axis. A screw-head engaging element is connected to the shaft for receiving the torque and transmitting the same to the screw-head about the longitudinal axis. The screw-head engaging element has a plurality of screw-head engaging surfaces for being engaged with respective surfaces of the screw-head. At least two of the screw-head engaging surfaces have a recess such that only an outer edge surface area of each of the at least two screw-head engaging surfaces is capable of engaging the respective surface of the screw-head.

### FIELD

The present invention relates to screwdriver bits for driving respective screw-heads, and more particularly, to anti-slip screwdriver bits capable of substantially reducing the likelihood of premature disengagement of the screwdriver bit from the screw-head.

### BACKGROUND

In present-day manufacturing and construction there are numerous different screw-head types and corresponding screwdriver bits in use. For example, in the construction industry, the two most commonly used screw-head/screwdriver bit types are the Robertson-type and the Phillips-type. Unfortunately, both of these screw-head/screwdriver bit types—as well as various other screw-head/screwdriver bit types—have a tendency to “cam-out,” i.e. the screwdriver bit slips up and out of the screw-head when the applied torque exceeds a threshold. While this feature can be employed to prevent application of excessive torque and resulting shearing-off of the screw-head, it frequently results in unwanted cam-outs of the screwdriver bits, particularly when the screwdriver bit is not exactly aligned with the screw-head. Premature cam-outs of the screwdriver bits frequently occur in a violent manner—in particular when used with power tools—injuring the hand of the user and damaging both the screw-head and the screwdriver bit. It may take only one cam-out incident to ruin a new screwdriver bit.

It may be desirable to provide an anti-slip screwdriver bit that is capable of substantially reducing the likelihood of premature disengagement of the screwdriver bit from the screw-head.

It may also be desirable to provide an anti-slip screwdriver bit that is implementable with existing screwdriver bit types.

It may also be desirable to provide an anti-slip screwdriver bit that is employable for driving existing screw-head types.

### SUMMARY

Accordingly, one object of the present invention is to provide an anti-slip screwdriver bit that is capable of substantially reducing the likelihood of premature disengagement of the screwdriver bit from the screw-head.

Another object of the present invention is to provide an anti-slip screwdriver bit that is implementable with existing screwdriver bit types.

Another object of the present invention is to provide an anti-slip screwdriver bit that is employable for driving existing screw-head types.

According to one aspect of the present invention, there is provided an anti-slip screwdriver bit for transmitting torque to a screw-head. The anti-slip screwdriver bit comprises a shaft for receiving the torque about its longitudinal axis. A screw-head engaging element is connected to the shaft for receiving the torque and transmitting the same to the screw-head about the longitudinal axis. The screw-head engaging element has a plurality of screw-head engaging surfaces for being engaged with respective surfaces of the screw-head. At least two of the screw-head engaging surfaces have a recess such that only an outer edge surface area of each of the at least two screw-head engaging surfaces is capable of engaging the respective surface of the screw-head.

According to one aspect of the present invention, there is provided an anti-slip screwdriver bit adapted for transmitting torque to a Phillips-type screw-head. The anti-slip screwdriver bit comprises a shaft for receiving the torque about its longitudinal axis. A screw-head engaging element is connected to the shaft for receiving the torque and transmitting the same to the screw-head about the longitudinal axis. The screw-head engaging element has four pairs of screw-head engaging surfaces with the screw-head engaging surfaces of each pair facing in opposite direction. Each of the screw-head engaging surfaces has a recess such that only one outer edge surface area is capable of engaging the respective surface of the screw-head.

According to one aspect of the present invention, there is provided an anti-slip screwdriver bit adapted for transmitting torque to a Robertson-type screw-head. The anti-slip screwdriver bit comprises a shaft for receiving the torque about its longitudinal axis. A screw-head engaging element is connected to the shaft for receiving the torque and transmitting the same to the screw-head about the longitudinal axis. The screw-head engaging element has a square shaped cross-section and four screw-head engaging surfaces. Each of the screw-head engaging surfaces has a recess such that two outer edge surface areas are capable of engaging the respective surface of the screw-head.

According to one aspect of the present invention, there is provided an anti-slip screwdriver bit adapted for transmitting torque to an Allen-type screw-head. The anti-slip screwdriver bit comprises a shaft for receiving the torque about its longitudinal axis. A screw-head engaging element is connected to the shaft for receiving the torque and transmitting the same to the screw-head about the longitudinal axis. The screw-head engaging element has a hexagon shaped cross-section and six screw-head engaging surfaces. Each of the screw-head engaging surfaces has a recess such that two outer edge surface areas are capable of engaging the respective surface of the screw-head.

One advantage of the present invention is that it provides an anti-slip screwdriver bit that is capable of substantially reducing the likelihood of premature disengagement of the screwdriver bit from the screw-head.

A further advantage of the present invention is that it provides an anti-slip screwdriver bit that is implementable with existing screwdriver bit types.

A further advantage of the present invention is that it provides an anti-slip screwdriver bit that is employable for driving existing screw-head types.

### BRIEF DESCRIPTION OF THE DRAWINGS

An embodiment of the present invention is described below with reference to the accompanying drawings, in which:

FIGS. 1a and 1b are simplified block diagrams illustrating in perspective views a Robertson-type anti-slip screwdriver bit according to an embodiment of the invention implemented for use with a power tool and a manual screwdriver, respectively;

FIGS. 1c to 1e are simplified block diagrams illustrating in a front view and two detailed front views, respectively, the screw-head engaging element of the Robertson-type anti-slip screwdriver bit according to an embodiment of the invention;

FIGS. 1f and 1g are simplified block diagrams illustrating in cross-sectional views a Robertson-type anti-slip screwdriver bit according to an embodiment engaged with a respective Robertson-type screw-head;

FIG. 2 is a simplified block diagram illustrating in a front view the screw-head engaging element of a Slot-type anti-slip screwdriver bit according to an embodiment of the invention;

FIG. 3 is a simplified block diagram illustrating in a front view the screw-head engaging element of an Allen-type anti-slip screwdriver bit according to an embodiment of the invention;

FIGS. 4a and 4b are simplified block diagrams illustrating in a side view and two cross-sectional views, respectively, a Phillips-type anti-slip screwdriver bit according to an embodiment of the invention;

FIGS. 4c and 4d are simplified block diagrams illustrating in cross-sectional views contact areas of the Phillips-type anti-slip screwdriver bit according to an embodiment when engaged with a respective Phillips-type screw-head; and,

FIGS. 5a and 5b are simplified block diagrams illustrating in a front view and a side view, respectively, manufacturing steps of the Phillips-type anti-slip screwdriver bit according to an embodiment of the invention.

### DETAILED DESCRIPTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, certain methods and materials are now described.

While the description of certain embodiments hereinbelow is with reference to Robertson-type, Slot-type, Allen-type, and Phillips-type screwdriver bits, it will become evident to those skilled in the art that the embodiments of the invention are not limited thereto, but that the anti-slip screwdriver bit design is also implementable with various other screwdriver bit types where desirable and where the screw-head engaging surfaces are of sufficient size such as, for example, PoziDriv®-type, and Pentagon-type.

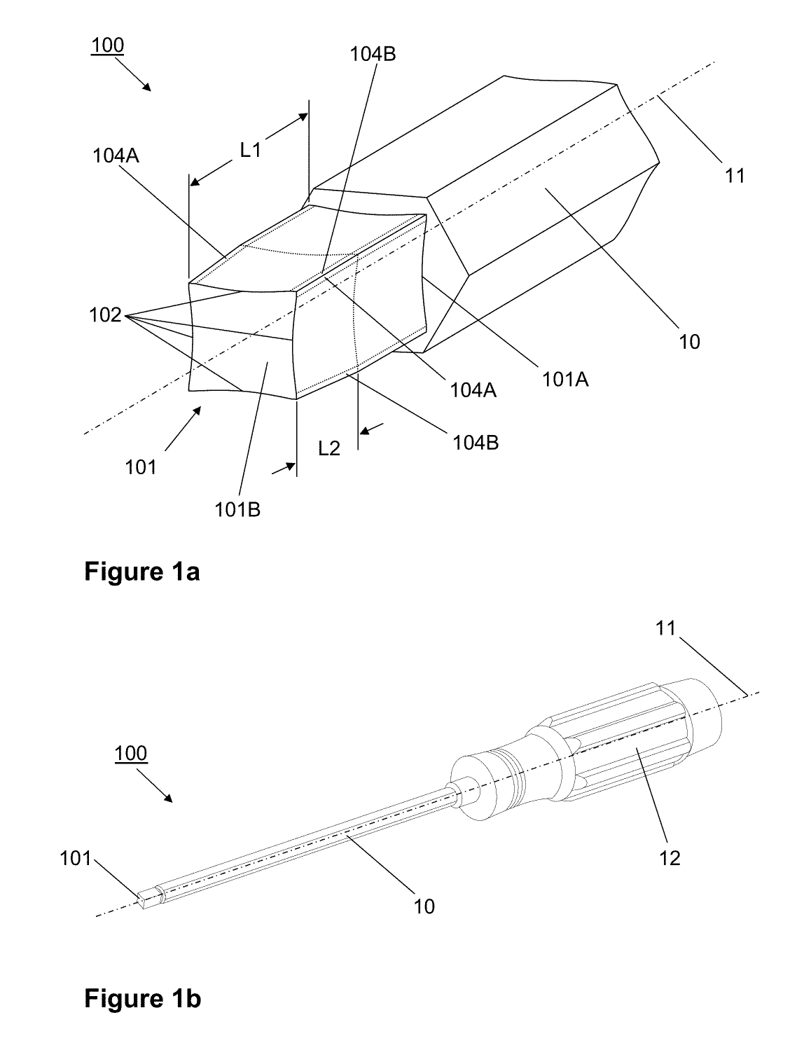

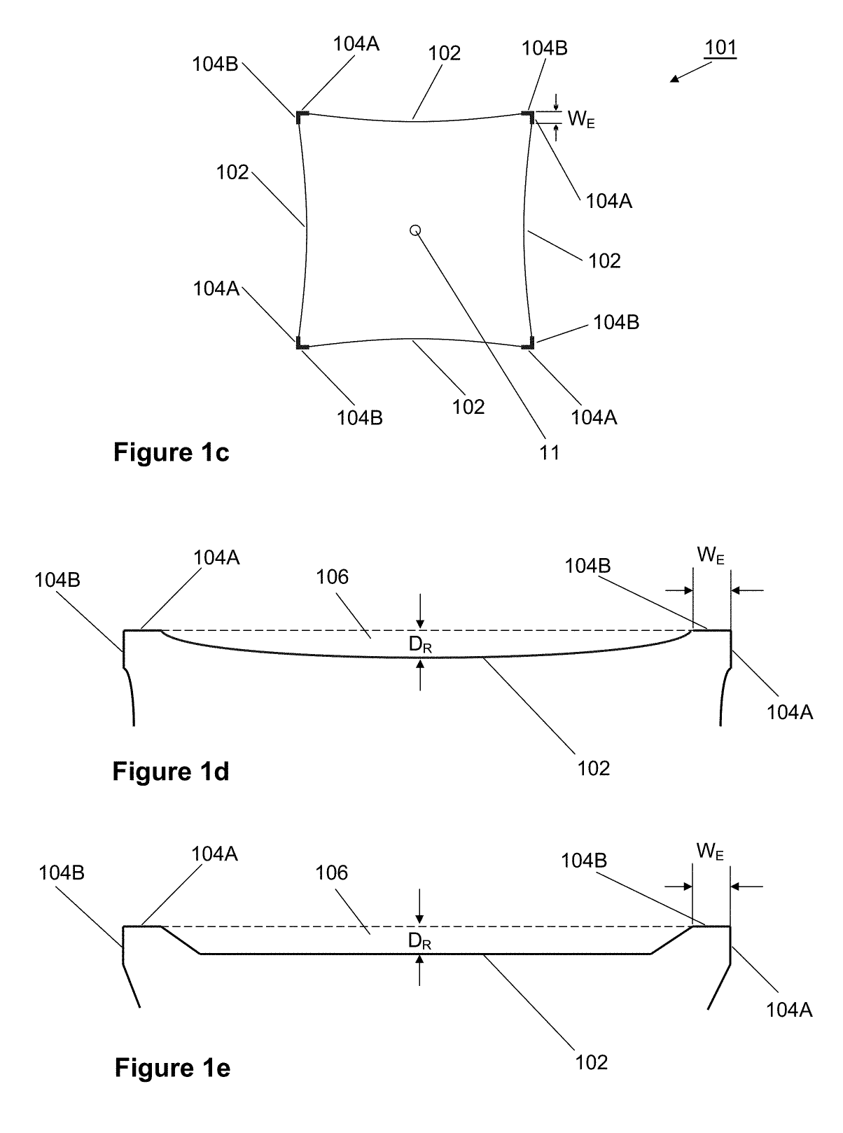

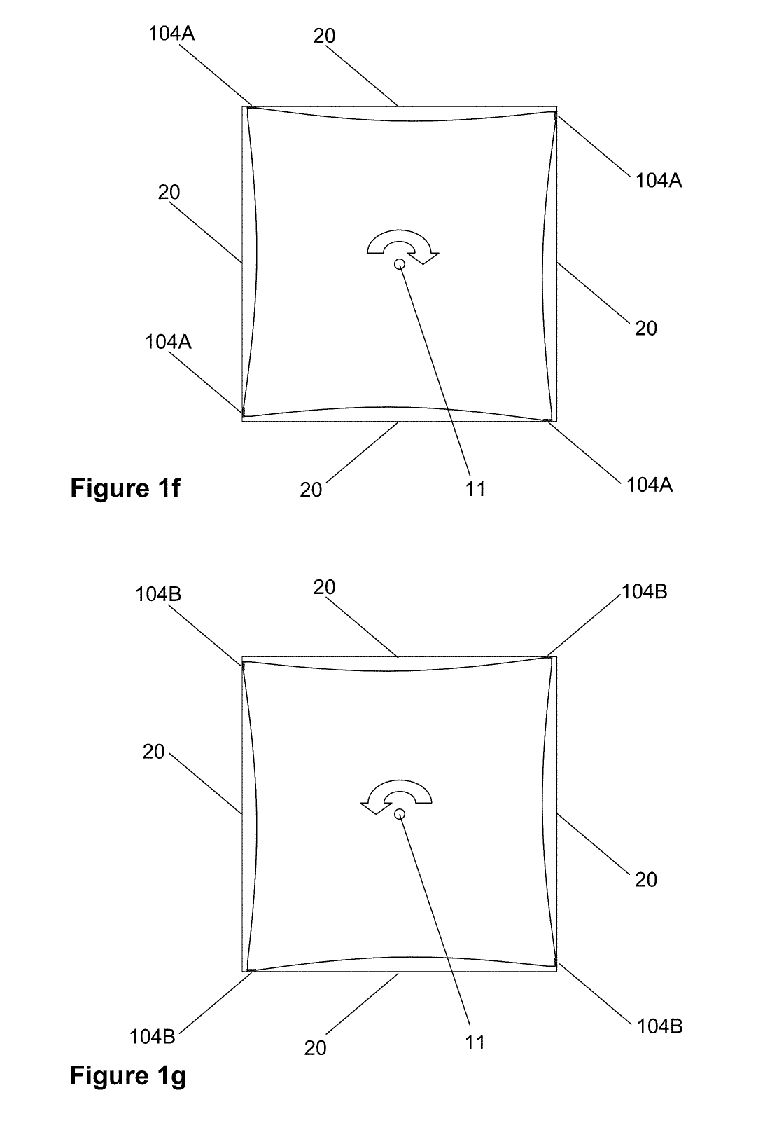

Referring to FIGS. 1a to 1g, an anti-slip screwdriver bit 100 for transmitting torque to a screw-head according to an embodiment of the invention is provided. The anti-slip screwdriver bit 100 is implementable for use with a power tool, as illustrated in FIG. 1a, or as a manual screwdriver having shaft 10 and handle 12, as illustrated in FIG. 1b. The anti-slip screwdriver bit 100 comprises a shaft 10 for receiving the torque about its longitudinal axis 11 for driving the screw-head. A screw-head engaging element 101—having length L1 between a proximal end 101A and a distal end 101B thereof—is connected to the shaft 10 for receiving the torque and transmitting the same to the screw-head about the longitudinal axis 11. The screw-head engaging element 101 has a plurality of screw-head engaging surfaces 102 for being engaged with respective surfaces of the screw-head. For example, the screw-head engaging element 101 has a square cross-section adapted for engaging a Robertson-type screw-head, as illustrated in FIGS. 1a to 1g. The screw-head engaging surfaces 102 have a recess 106 such that only outer edge surface areas 104A, 104B of each of the screw-head engaging surfaces 102 are capable of engaging the respective surface of the screw-head. Each screw-head engaging surface 102 has two outer edge surface areas 104A and 104B with the outer edge surface areas 104A and 104B having a predetermined width W_{E} and, in one case, extending the length L1 of the screw-head engaging element 101, as illustrated in FIGS. 1a and 1c.

Optionally, the screw-head engaging element 101 has a slightly tapered distal portion of length L2 with the outer edge surface areas 104A and 104B extending the complete length L1 of the screw-head engaging element 101, as illustrated in FIG. 1a.

Alternatively, provision of the recess is omitted on some of the four screw-head engaging surfaces 102. For example, only two oppositely placed screw-head engaging surfaces 102 have a recess.

The recess 106 can have a concave curved surface placed between the two flat outer edge surface areas 104A and 104B with a maximum depth D_{R} in proximity of the center of the screw-head engaging surface 102, as illustrated in FIG. 1d. Alternatively, the recess 106 is differently shaped such as, for example, having a flat center surface at depth D_{R} and slopes connecting the same to the two flat outer edge surface areas 104A and 104B, as illustrated in FIG. 1e. FIGS. 1f an 1g illustrate the screw-head engaging element 101 placed inside a respective screw-head. When the torque is applied in clockwise direction—indicated by the block arrow in FIG. 1f—the outer edge surface areas 104A are engaged with the respective screw-head surfaces 20. When the torque is applied in counter-clockwise direction—indicated by the block arrow in FIG. 1g—the outer edge surface areas 104B are engaged with the respective screw-head surfaces 20.

Reducing the contact area between the screw-head engaging element 101 and the screw-head surfaces 20 to the outer edge surface areas 104A, 104B substantially increases the contact pressure at these contact areas when torque is applied, substantially increasing friction between the screw-head engaging element 101 and the screw-head. The increased friction substantially reduces the likelihood of slip-up and premature disengagement of the screw-head engaging element 101 from the screw-head. The best placement for the contact areas is at the outer edges of the screw-head engaging surfaces 102, showing a substantial reduction of the likelihood of premature disengagement compared to conventional screwdriver bit designs, even when the screwdriver bit is not in good alignment with the screw-head. The anti-slip screwdriver bit 100 enables the user to exert less force along the longitudinal axis 11 in order to keep the anti-slip screwdriver bit 100 engaged with the screw-head and/or to apply higher torque loads.

Optionally, the outer edge surface areas are provided with means to further increase friction such as, for example, grooves, or ridges.

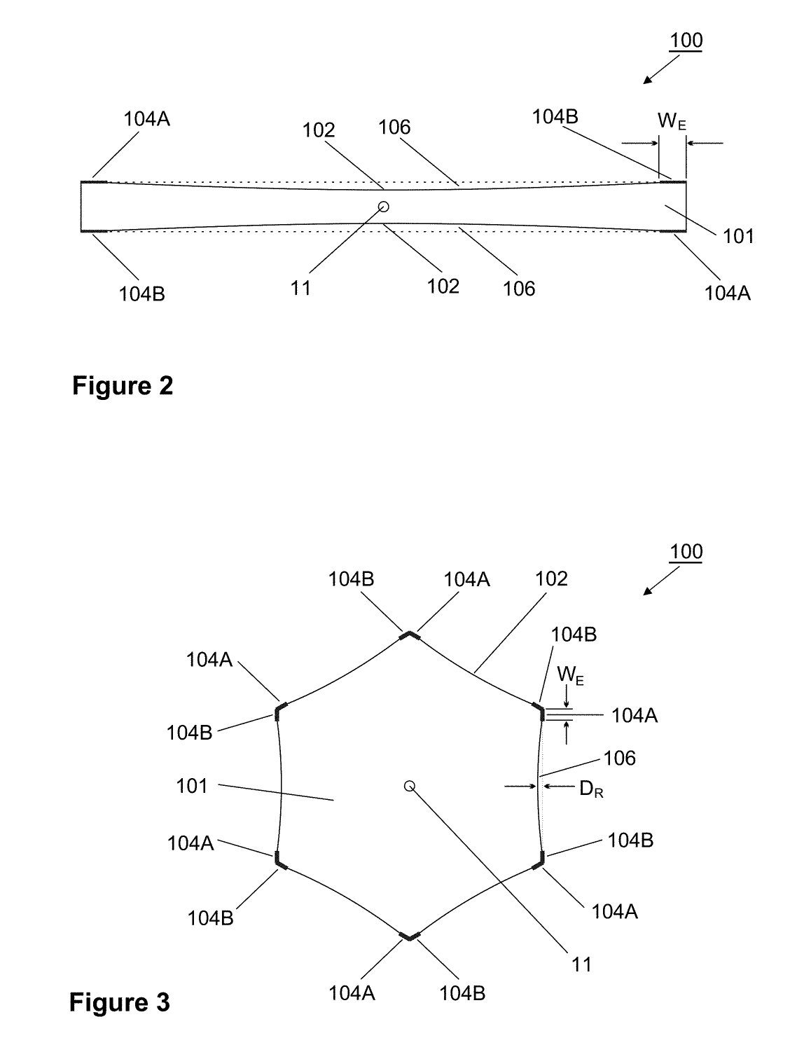

Referring to FIG. 2, an anti-slip screwdriver bit 100 for transmitting torque to a screw-head according to another embodiment of the invention is provided. Here, the screw-head engaging element 101 comprises two substantially parallel screw-head engaging surfaces 102 facing in opposite directions to form a Slot-type screwdriver bit. Each screw-head engaging surface 102 has recess 106 placed between two outer edge surface areas 104A and 104B with the outer edge surface areas 104A and 104B having a predetermined width W_{E} and, in one case, extending the length L1 of the screw-head engaging element 101. When the torque is applied in clockwise direction about the longitudinal axis 11, the outer edge surface areas 104A are engaged with respective screw-head surfaces. When the torque is applied in counter-clockwise direction about the longitudinal axis 11, the outer edge surface areas 104B are engaged with the respective screw-head surfaces.

Referring to FIG. 3, an anti-slip screwdriver bit 100 for transmitting torque to a screw-head according to another embodiment of the invention is provided. Here, the cross-section of the screw-head engaging element 101 is a hexagon-shaped comprising six screw-head engaging surfaces 102 forming an Allen-type screwdriver bit or an Allen key. Each screw-head engaging surface 102 has recess 106 with depth D_{R} placed between two outer edge surface areas 104A and 104B with the outer edge surface areas 104A and 104B having a predetermined width W_{E} and, in one case, extending the length L1 of the screw-head engaging element 101. When the torque is applied in clockwise direction about the longitudinal axis 11, the outer edge surface areas 104A are engaged with respective screw-head surfaces. When the torque is applied in counter-clockwise direction about the longitudinal axis 11, the outer edge surface areas 104B are engaged with the respective screw-head surfaces.

It is noted that the invention may be implemented with cross-sections of the screw-head engaging element 101 forming other types of convex polygons such as, for example, a pentagon.

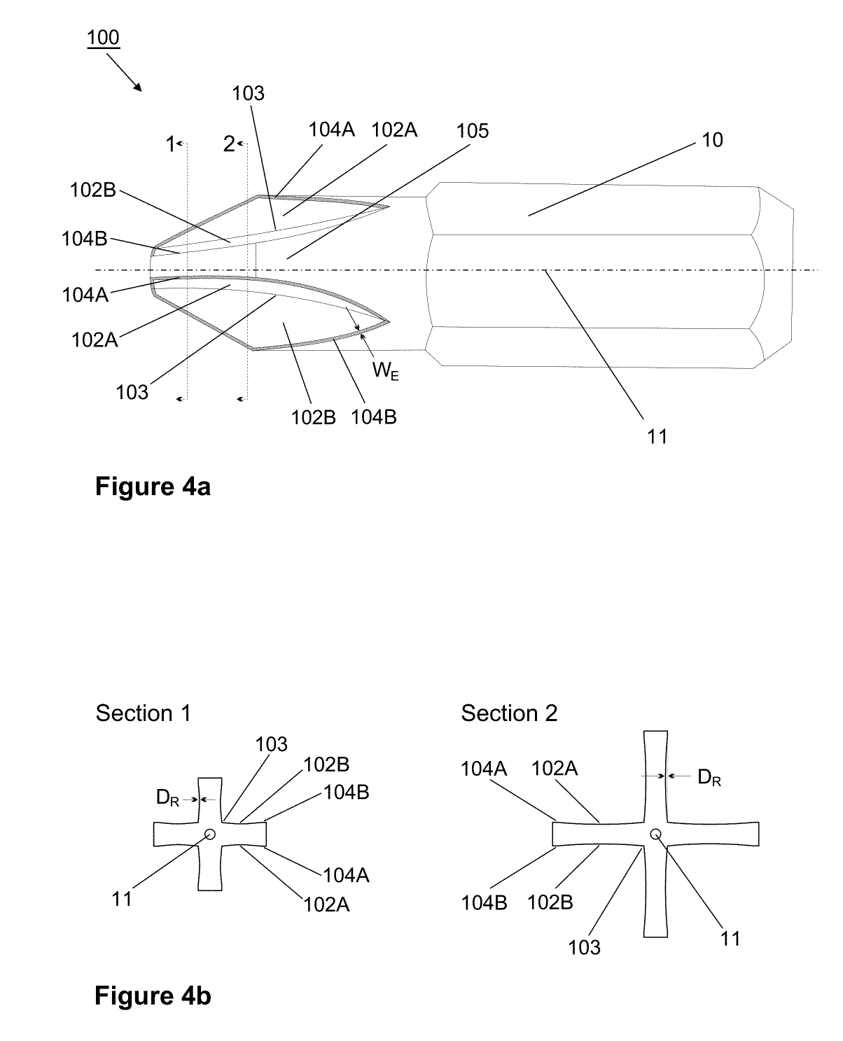

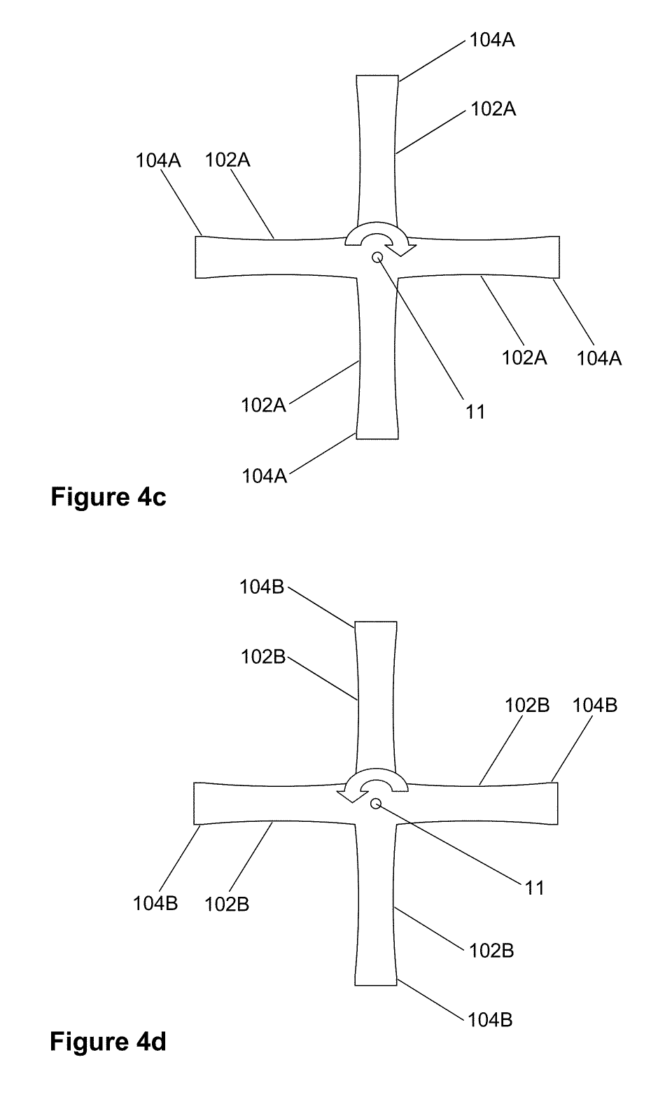

Referring to FIGS. 4a to 4d, an anti-slip screwdriver bit 100 for transmitting torque to a screw-head according to another embodiment of the invention is provided. Here, the screw-head engaging element 101 comprises four pairs of screw-head engaging surfaces 102A and 102B, with the screw-head engaging surfaces 102A and 102B being adapted for engaging a Phillips-type screw-head. Each pair of screw-head engaging surfaces 102A and 102B forms a blade 105 of the screw-head engaging element 101 with the screw-head engaging surfaces 102A and 102B facing in opposite direction. Each of the plurality of screw-head engaging surfaces 102A, 102B has one outer edge surface area 104A, 104B capable of engaging the respective surface of the screw-head and is recessed towards connecting area 103 with a neighboring screw-head engaging surface. When the torque is applied in clockwise direction—indicated by the block arrow in FIG. 4c—the outer edge surface areas 104A of screw-head engaging surfaces 102A are engaged with respective screw-head surfaces. When the torque is applied in counter-clockwise direction—indicated by the block arrow in FIG. 4d—the outer edge surface areas 104B of screw-head engaging surfaces 102B are engaged with respective screw-head surfaces.

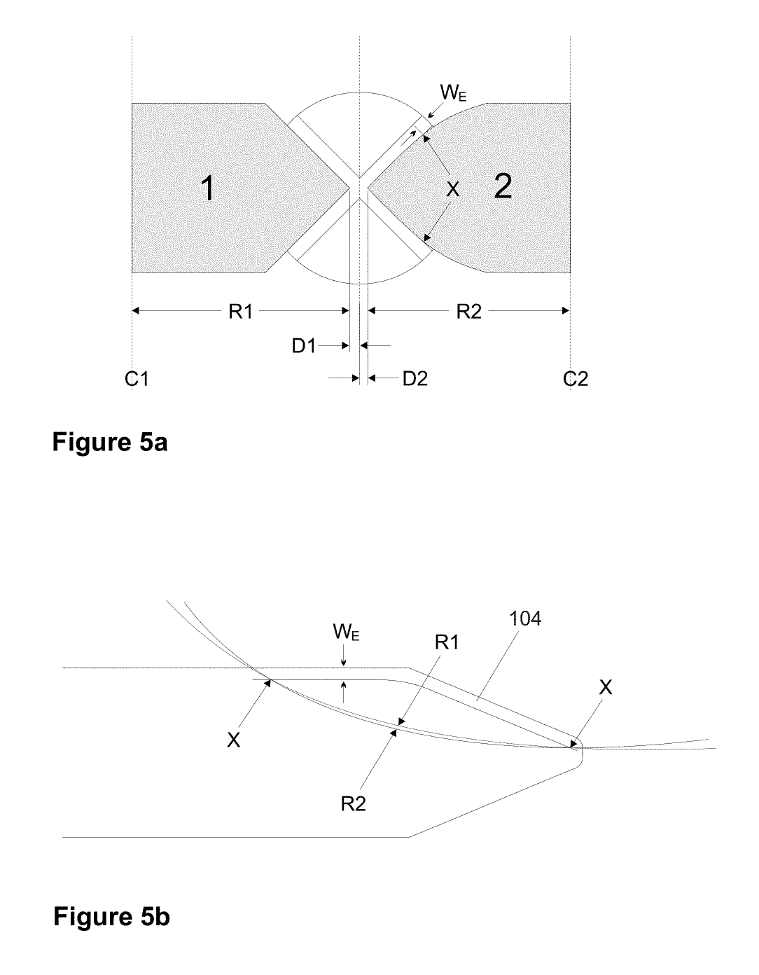

The anti-slip screwdriver bit 100 is, in one case, made of hardened steel such as, for example, induction-hardened or surface heat treated steel using conventional forging and machining techniques. For example, in a first step, the anti-slip screwdriver bit 100 is produced employing a conventional grinding process providing a conventionally shaped screwdriver bit. In a following second step, using a different shaped cutting tool, the recess 106 is cut while leaving the outer edge surface area 104. Therefore, the anti-slip screwdriver bit 100 is produced by just adding one additional grinding step to the same conventional manufacturing process, as illustrated in FIGS. 5a and 5b for the manufacturing of a Phillips-type anti-slip screwdriver bit 100. In the first step, a conventional cutting blade—item 1 in FIG. 5a—spins around axis C1 cutting at arc radius R1 at a depth D1. In the second step, a modified cutting blade—item 2 in FIG. 5a—having a curved cutting face is employed spinning around axis C2 cutting at a smaller arc radius R2 and a slightly deeper depth D2. The second step results in material being cut away only in the desired recess area as the cutting blade leaves the screwdriver bit at locations X, leaving the outer edge surface area 104 untouched.

The width W_{E} of the outer edge surface area 104 is determined such that it is small enough to provide substantially increased friction while being large enough to prevent the anti-slip screwdriver bit 100 from wearing out prematurely. The depth D_{R} and shape of the recess 106 are determined to be sufficient to limit contact with the screw-head to the outer edge surface area 104 while being sufficiently shallow to minimize weakening of the screw-head engaging element 101. The outer edge surface area 104 and the recess 106 are determined using standard engineering and material science technology in dependence upon: the size and type of the anti-slip screwdriver bit 100; the maximum torque to be applied; the material of the anti-slip screwdriver bit 100; and, the process employed for manufacturing the anti-slip screwdriver bit 100.

The entire contents of Canadian Patent Application 2,898,480, published on Jan. 27, 2017 are incorporated herein by reference.

The present invention has been described herein with regard to certain embodiments. However, it will be obvious to persons skilled in the art that a number of variations and modifications can be made without departing from the scope of the invention as described herein.

What is claimed is:

1. An anti-slip screwdriver bit for transmitting torque to a screw-head comprising:
a shaft for receiving the torque about its longitudinal axis;
a screw-head engaging element connected to the shaft for receiving the torque and transmitting the same to the screw-head about the longitudinal axis, the screw-head engaging element having a plurality of screw-head engaging surfaces for being engaged with respective surfaces of the screw-head, wherein at least two of the screw-head engaging surfaces have a recess such that only an outer edge surface area of each of the at least two screw-head engaging surfaces is capable of engaging the respective surface of the screw-head.

2. The screwdriver bit according to claim 1 wherein the recess has a concave curved surface.

3. The screwdriver bit according to claim 1 wherein each of the plurality of screw-head engaging surfaces has a recess.

4. The screwdriver bit according to claim 3 wherein each of the plurality of screw-head engaging surfaces has one outer edge surface area capable of engaging the respective surface of the screw-head.

5. The screwdriver bit according to claim 4 wherein the screw-head engaging surfaces are arranged in pairs with the screw-head engaging surfaces of each pair facing in opposite direction.

6. The screwdriver bit according to claim 5 wherein the screw-head engaging element comprises four pairs of screw-head engaging surfaces.

7. The screwdriver bit according to claim 6 wherein the screw-head engaging surfaces are adapted for engaging a Phillips-type screw-head.

8. The screwdriver bit according to claim 3 wherein each of the plurality of screw-head engaging surfaces has two outer edge surface areas capable of engaging a respective surface of the screw-head.

9. The screwdriver bit according to claim 8 wherein the screw-head engaging element comprises two substantially parallel screw-head engaging surfaces facing in opposite directions.

10. The screwdriver bit according to claim 8 wherein a cross-section of the screw-head engaging element forms a convex polygon.

11. The screwdriver bit according to claim 10 wherein the cross-section of the screw-head engaging element forms one of a square and a hexagon.

12. The screwdriver bit according to claim 11 wherein the screw-head engaging surfaces are adapted for engaging a Robertson-type screw-head.

13. The screwdriver bit according to claim 11 wherein the screw-head engaging surfaces are adapted for engaging an Allen-type screw-head.
